(19) United States
(12) Patent Application Publication
(10) Pub. No.: US 2014/0118123 A1
(43) Pub. Date: May 1, 2014

(54) METHOD AND APPARATUS FOR CONTROLLING HOME DEVICE BASED ON SERVICE LOGIC IN HOME NETWORK SYSTEM

(71) Applicant: Samsung Electronics Co., Ltd., Suwon-si (KR)

(72) Inventors: Nae-Hyun LIM, Seoul (KR); Dong-Keon KONG, Suwon-si (KR); Do-Young KIM, Hwaseong-si (KR); Sang-Ho LEE, Seongnam-si (KR)

(73) Assignee: Samsung Electronics Co., Ltd., Suwon-si (KR)

(21) Appl. No.: 14/067,073

(22) Filed: Oct. 30, 2013

(30) Foreign Application Priority Data
Oct. 31, 2012 (KR) 10-2012-0121971

(51) Int. Cl. G08C 19/00

(52) U.S. Cl. CPC G08C 19/00
USPC 340/12.53

(57) ABSTRACT

A method of controlling at least one home device in a home network system through a home gateway is provided. The method includes transmitting information about at least one home device installed in a home to a server, receiving extracted scenario information configured with combinations of services that are providable through the at least one home device from the server, and transmitting the extracted scenario information to a user terminal, receiving a control signal corresponding to a scenario selected by the user terminal from the user terminal, and if an event signal is detected from the at least one home device corresponding to the selected scenario, controlling the at least one home device according to the selected scenario.

### CROSS-REFERENCE TO RELATED APPLICATION(S)

This application claims the benefit under 35 U.S.C. §119(a) of a Korean patent application filed on Oct. 31, 2012 in the Korean Intellectual Property Office and assigned Serial No. 10-2012-0121971, the entire disclosure of which is hereby incorporated by reference.

### TECHNICAL FIELD

The present disclosure relates to a home network system. More particularly, the present disclosure relates to a method and apparatus for controlling a home device based on service logic.

### BACKGROUND

A home network system connects home devices, such as a refrigerator, an air conditioner, a television, and a Personal Computer (PC), installed in home, to each other through a wired/wireless network to enable the home devices to communicate with each other. The home network system can control the home devices according to a request from a user to provide the user's desired service to the user. However, home network systems according to the related art could provide only limited services.

Lately, with variety of home devices and variety of users' requirements, there is a need to provide optimal services in response to various requirements.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for enabling a server to configure a fluid service logic in a home network system to control a home device based on the service combination.

In accordance with an aspect of the present disclosure, a method for controlling at least one home device in a home network system through a home gateway is provided. The method includes transmitting information about the at least one home device installed in a home to a server, receiving extracted scenario information configured with combinations of services that are providable through the at least one home device from the server, and transmitting the extracted scenario information to a user terminal, receiving a control signal corresponding to a scenario selected by the user terminal from the user terminal, and if an event signal is detected from the at least one home device corresponding to the selected scenario, controlling the at least one home device according to the selected scenario.

In accordance with another aspect of the present disclosure, a method for controlling at least one home device in a home network system through a server is provided. The method includes receiving information about the at least one home device installed in a home from a home gateway, extracting scenarios configured with combinations of services that are providable through the at least one home device, and transmitting extracted scenario information including the extracted scenarios to the home gateway.

In accordance with another aspect of the present disclosure, a method for controlling at least one home device in a home network system though a user terminal is provided. The method includes receiving extracted scenario information configured with combinations of services that are providable through the at least one home device installed in a home from a home gateway, selecting one scenario from among scenarios included in the extracted scenario information, and transmitting a control signal corresponding to the selected scenario to the home gateway.

In accordance with another aspect of the present disclosure, a home gateway configured to control at least one home device in a home network system is provided. The home gateway includes a receiver configured to receive information about the at least one home device installed in a home from the at least one home device, to receive extracted scenario information configured with combinations of services that are providable through the at least one home device, from a server, and to receive a control signal corresponding to a scenario selected by a user terminal from the user terminal, a transmitter configured to transmit the information about the at least one home device to the server, and to transmit the extracted scenario information to the user terminal, and a controller configured to control, if an event signal is detected from the at least one home device corresponding to the selected scenario, the at least one home device according to the selected scenario.

In accordance with another aspect of the present disclosure, a server configured to control at least one home device in a home network system is provided. The server includes a receiver configured to receive information about the at least one home device installed in a home from a home gateway, an extractor configured to extract scenario information configured with combinations of services that are providable through the at least one home device, and a transmitter configured to transmit the extracted scenario information to the home gateway.

In accordance with another aspect of the present disclosure, a user terminal configured to control at least one home device in a home network system is provided. The user terminal includes a receiver configured to receive extracted scenario information configured with combinations of services that are providable through the at least one home device installed in a home from a home gateway, a selector configured to select one scenario among scenarios included in the extracted scenario information, and a transmitter configured to transmit a control signal corresponding to the selected scenario to the home gateway.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a method of controlling a home device, according to a first embodiment of the present disclosure;

FIG. 2 illustrates a method of controlling a home device, according to a second embodiment of the present disclosure;

FIG. 3 is a flowchart of a method in which a home gateway operates in the second embodiment of the present disclosure;

FIG. 4 is a flowchart of a method in which a server operates in the second embodiment of the present disclosure;

FIG. 5 is a flowchart of a method in which a terminal operates in the second embodiment of the present disclosure;

FIG. 6 is a block diagram illustrating a configuration of the home gateway in the second embodiment of the present disclosure;

FIG. 7 is a block diagram illustrating a configuration of the server in the second embodiment of the present disclosure;

FIG. 8 is a block diagram illustrating a configuration of the terminal in the second embodiment of the present disclosure; and

FIG. 9 illustrates a method of controlling a home device, according to a third embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the singular forms “a”, “an” and “the” are intended to include the plural forms as well, unless the context clearly indicates otherwise.

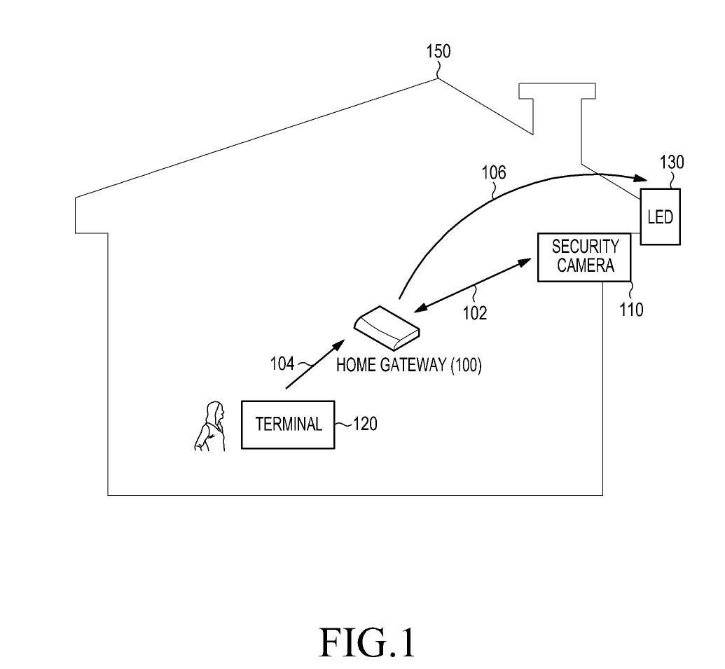

FIG. 1 illustrates a method of controlling a home device, according to a first embodiment of the present disclosure.

Referring to FIG. 1, a home network system 150 includes a terminal 120, a home gateway (HGW) 100, and first and second devices 110 and 130. In FIG. 1, the first device 110 is assumed to be a security camera newly installed in a home, and the second device 130 is assumed to be a Light-Emitting Diode (LED) installed in the home. However, the first and second devices 110 and 130 may be any other devices installable in the home. Also, the terminal 120 is assumed to be a smart phone, however, the terminal 120 may be any other device, such as a tablet Personal Computer (PC) or a notebook computer, which can communicate with the home gateway 100.

The home gateway 100 registers information about devices installed in the home. If the home gateway 100 receives a control signal for controlling a device, from the terminal 120, the home gateway 100 transmits the control signal to the corresponding device according to the control signal and the information about the registered devices.

If a device, for example, the first device 110 is newly installed in home, the home gateway 100 stores information about the first device 110, for example, a device Identifier (ID) and service capability information of the first device 110. The service capability information of the first device 110 is information about services that the first device 110 can provide. The service capability information of the first device 110 may be acquired through a service discovery procedure. The service capability information of the first device 110 may be a zoom-in/zoom-out function of the security camera 110.

If the home gateway 100 receives a control signal for controlling a device from the terminal 120 in operation 104, the home gateway 100 detects the device to which the control signal is to be applied, according to the control signal and the information about the registered devices, and transmits the control signal to the detected device. For example, if the home gateway 100 receives a control signal for controlling the LED 130 from the terminal 120 in operation 104, the home gateway 100 detects the LED 130 to which the control signal is to be applied, and transmits the control signal to the LED 130 in operation 106. Herein, the control signal for controlling the LED 130 may be a control signal for turning on/off the LED 130, or a control signal for adjusting the brightness of the LED 130.

If the home gateway 100 receives a control signal for controlling the security camera 110 from the terminal 120 in operation 104, the home gateway 100 detects the security camera 110 to which the control signal is to be applied, and transmits a control signal to the security camera 110 in operation 102. The control signal for controlling the security camera 110 may be a signal for controlling the security camera 110 to start or stop recording, or a signal for controlling the security camera 110 to change a photographing direction. However, it is noted that these signals are merely exemplary and the control signals may be used for other control purposes of the camera. The security camera 110 transmits photographed image information to the home gateway 100, and also stores and retrieves the photographed image information. When there is a request from the terminal 120, the security camera 110 may transmit the stored image information to the terminal 120.

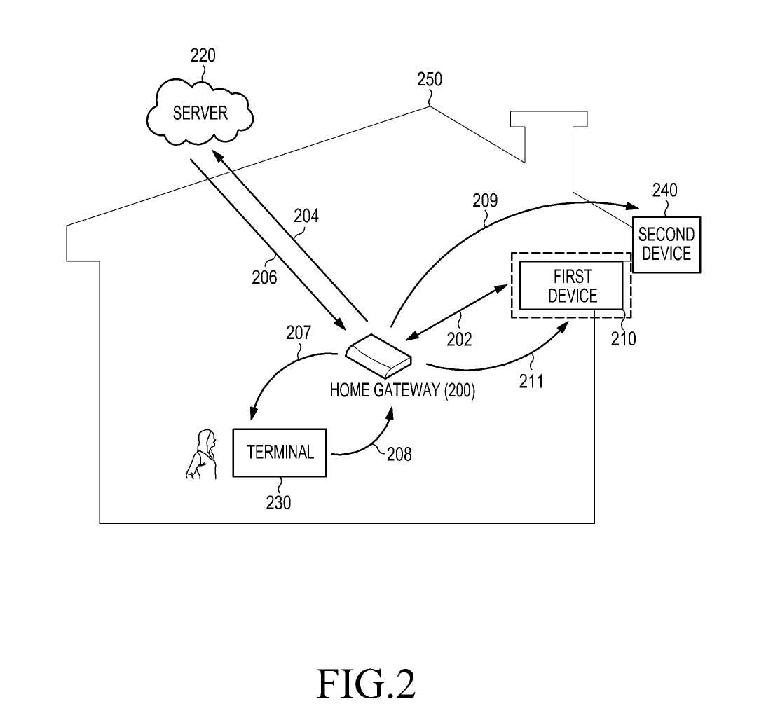

FIG. 2 illustrates a method of controlling a home device, according to a second embodiment of the present disclosure.

Referring to FIG. 2, a home network system 250 includes a terminal 230, a home gateway 200, first and second devices 210 and 240, and a server 220. In FIG. 2, the first device 210 is assumed to be a security camera newly installed in a home, and the second device 240 is assumed to be an LED installed in the home. However, the first and second devices 210 and 220 may be any other devices installable in the home. The terminal 230 is assumed to be a smart phone, however, the terminal 230 may be any other device, such as a tablet PC or a notebook computer, which can communicate with the home gateway 200.

The home gateway 200 may register device information including IDs of all the devices installed in the home, service capability information of the devices, user information, user terminal information, region information, etc. in operation 202, and transmit the registered device information, user information, user terminal information, and region information to the server 220 in operation 204. Herein, the device information may be device IDs, the user information may be family members' mobile phone numbers, gender, age, physical conditions, etc., the user terminal information may be information about applications stored in the user terminal, and the region information may be a home address.

If a device, for example, the first device 210 is newly installed in the home, the home gateway 200 may store a device ID and service capability information of the first device 210, and transmit the device ID and service capability information of the first device 210 to the server 220 in operation 204. The service capability information of the first device 210 may be information about services that the first device 210 can provide. The service capability information of the first device 210 may be acquired through a service discovery procedure in operation 202 but is not limited thereto. The service capability information of the first device 210 may be a zoom-in/zoom-out function of the security camera 210.

The server 220 may receive device information about all of the devices installed in the home, user information, user terminal information, and region information, from the home gateway 200, in operation 204, store the received information in Database (DB) of the server 220, and extract scenarios configured with combinations of all services that can be provided to a user, based on the stored information in Database.

Scenarios for all services that can be provided to the user will be described in more detail with reference to Table 1 below. In Table 1, it is assumed that the devices installed in the home are an intrusion detection sensor, a security camera, a LED, an air conditioner, and a gas valve, wherein the service capability information of the intrusion detection sensor includes a user notification function and a buzz function, the service capability information of the security camera includes a user notification function, a zoom-in/zoom-out function, and a photographing direction changing function, the service capability information of the LED includes an on/off function and a brightness adjustment function, the service capability information of the air conditioner includes an on/off function, an adjustment-of-setting temperature function, an adjustment-of-fan speed function, and an adjustment-of-fan movement function, and the service capability information of the gas valve includes a user notification function and a close/open function.

TABLE 1

| Device ID | Providable Service | | Scenario |
|---|---|---|---|
| A (Intrusion | 1. | Send a Notification Message to a | Scenario 1: |
| Detection | | User When Intrusion Is Detected | A1 + A2 |
| Sensor) | 2. | Make a Buzz Sound When | Scenario 2: |
| | | Intrusion Is Detected | A1 + A2 + |
| B (Security | 1. | Zoom-in/Zoom-out | B1 + B2 |
| Camera) | 2. | Send Photographing Information | Scenario 3: |
| | | to a User If an Intruder has | A1 + A2 + B3 |
| | | been photographed | Scenario 4: |
| | 3. | Change Photographing Direction | B2 + B3 + C1 |
| C (LED) | 1. | Turn on/off | Scenario 5: |
| | 2. | Adjust Brightness (Turn up/down) | E1 + E2 |
| D (Air | 1. | Adjust Set Temperature (Turn Set | Scenario 6: |
| Conditioner) | | Temperature Up/Down) | C2 + D1 + D2 |
| | 2. | Adjust Fan Speed (Fast/Slow) | . . . |
| | 3. | Adjust Movement of Fan | |
| | | (Fixed/Rotation) | |
| E (Gas | 1. | Send a Notification Message to a | |
| Valve) | | User | |
| | 2. | Close/Open | |

Since the service capability information of the intrusion detection sensor having a device ID A includes a user notification function and a buzz function, the intrusion detection sensor may provide a user with a service of sending a notification message to a user when an intruder has been detected and a service of making a buzz sound when an intruder has been detected.

Since the service capability information of the security camera having a device ID B includes a user notification function, a zoom-in/zoom-out function, and a direction changing function, the security camera may provide a user with a zoom-in/zoom-out service of zooming in/out when an intruder has been detected, a service of changing a photographing direction along a traveling path of the intruder, and a service of providing photographed image information to a user.

Since the service capability information of the LED having a device ID C includes an on/off function and a brightness adjusting function, the LED may provide a user with a service of turning on/off the LED and a service of adjusting the brightness of the LED.

Since the service capability information of the air conditioner having a device ID D includes an on/off function, an adjustment-of-set temperature function, an adjustment-of-fan speed function, and an adjustment-of-fan movement function, the air conditioner may provide a user with a service for turning on/off the air conditioner, a service of turning a set temperature up or down, a service of adjusting fan speed, and a service of adjusting the movement of the fan.

Since the service capability information of the gas valve having a device ID E includes a user notification function and a close/open function, the gas valve may provide a user with a service of sending a notification message to a user when gas leaks out or when the gas valve opens for a predetermined time period or more, and a service of closing/opening the gas valve.

Extracted scenario information includes scenarios that are extracted by the server 220, and the scenarios are configured with combinations of all services that at least one home device can provide to the user.

The scenario 1 is a process set to send a notification message to a user and make a buzz sound when the intrusion detection sensor has detected an intruder.

The scenario 2 is a process set to send a notification message to a user and make a buzz sound when the intrusion detection sensor has detected an intruder, and set to cause the security camera to zoom-in on the intruder, to photograph a close-up of the intruder, and to send the photographed image information to the user.

The scenario 3 is a process set to send a notification message to a user and make a buzz sound when the intrusion detection sensor has detected an intruder, and set to cause the security camera to change a photographing direction along a traveling path of the intruder to photograph the intruder.

The scenario 4 is a process set to cause the security camera to change a photographing direction along a traveling path of an intruder, to photograph the intruder, and to send the photographed image information to a user, and set to turn on a LED installed in a region corresponding to the traveling path of the intruder.

The scenario 5 is a process set to send a notification message informing of a dangerous situation to a user when a gas valve remains open while the user is out, and set to automatically close the gas valve.

The scenario 6 is a process set to turn the brightness of the LED up, to turn the set temperature of the air conditioner up, and to adjust the fan speed of the air conditioner to the light level according to an environment, for example, when the sun sets the brightness of the LEDs are turned up since the inside of the house becomes dark and the temperature of the air conditioner is turned up since the outside temperature falls down.

For convenience of description, Table 1 shows some of scenarios for all services that can be provided to a user. However, the extracted scenario information includes all scenarios configured with combinations of services that can be provided by the respective home devices, as well as the scenarios 1 to 6 shown in Table 1.

As such, the server 220 may transmit extracted scenario information for all services that can be provided to the user, to the home gateway 200, in operation 206. At this time, the server 220 may determine whether the terminal 230 stores applications for executing the corresponding scenarios based on the stored terminal information, and if the terminal 230 does not store the applications, the server 220 may transmit the applications to the home gateway 200 together with the extracted scenario information. The home gateway 200 may transmit the extracted scenario information and the applications received from the server 220 to the terminal 230 in operation 207.

Also, when the server 220 may transmit the extracted scenario information to the terminal 230 through the home gateway 200, the server 220 may transmit a specialized scenario to the corresponding user based on the stored user information and region information. For example, the server 220 may provide a female user who lives alone in a region having a high crime rate, with scenarios (that is, the scenarios 1 to 3) specialized for devices corresponding to the device IDs A and B among the extracted scenario information, based on the stored user information and region information. As another example, the server 220 may provide an old man/woman who cannot move about freely, with a scenario (that is, the scenario 6) specialized for devices corresponding to the device IDs C and D.

As another example, the scenarios 1 to 3, which are provided to a female user who lives alone in a region having a high crime rate, may extend from the process shown in Table 1 to be set to dial 911 when the intrusion detection sensor has detected an intruder so as to inform that an intruder has entered the user's home.

The terminal 230 which has received the extracted scenario information from the server 220 through the home gateway 200 may select an optimal scenario from the extracted scenario information, and transmit a control signal corresponding to the selected scenario to the home gateway 200, in operation 208. The control signal may include a device ID of the device included in the selected scenario, and information about a service that is provided by the corresponding device. The home gateway 200 may detect a device to which the control signal is to be applied, according to the control signal and information about registered devices, and transmit the control signal to the detected device, in operations 209 and 211.

For example, the terminal 230 selects the scenario 4 as an optimal scenario, and transmits a control signal corresponding to the scenario 4 to the home gateway 200 in operation 208. The home gateway 200 which has received the control signal detects the first and second devices 210 and 240 to which the control signal is to be applied, according to a device ID and information about a service that is provided by the corresponding device, included in the control signal, and information about registered devices. Thereafter, if the first device 240 has detected an intruder and transmitted an event signal to the home gateway 200, the home gateway 200 transmits a control signal corresponding to the scenario 4 selected by the terminal 230 to the first and second devices 210 and 240 so as for the first and second devices 210 and 240 to operate according to a process set in the scenario 4. That is, the home gateway 200 transmits the control signal to the first and second devices 210 and 240 such that the first device 210 changes a photographing direction along a traveling path of the intruder, photographs the intruder, and transmits the photographed image information to the user, and the second device 240 which is a LED is turned on, in operations 209 and 211.

Although not illustrated in FIG. 2, the home gateway 200 may update device information when there is a change in the devices installed in home. For example, if a device has been newly installed in the home, as described above, the home gateway 200 transmits a device ID and service capability information of the newly installed device to the server 220. If a device installed in home has been removed, the home gateway 200 transmits information informing that the device has been removed, to the server 220. Then, the server 220 can extract scenarios configured with combinations of all services that can be provided to the user based on information of devices changed in the home network system, and transmit the extracted scenario information to the home gateway 200. The home gateway 200 can transmit the extracted scenario information to the terminal 230, and the terminal 230 transmits a control signal corresponding to a scenario selected from the extracted scenario information, to the home gateway 200.

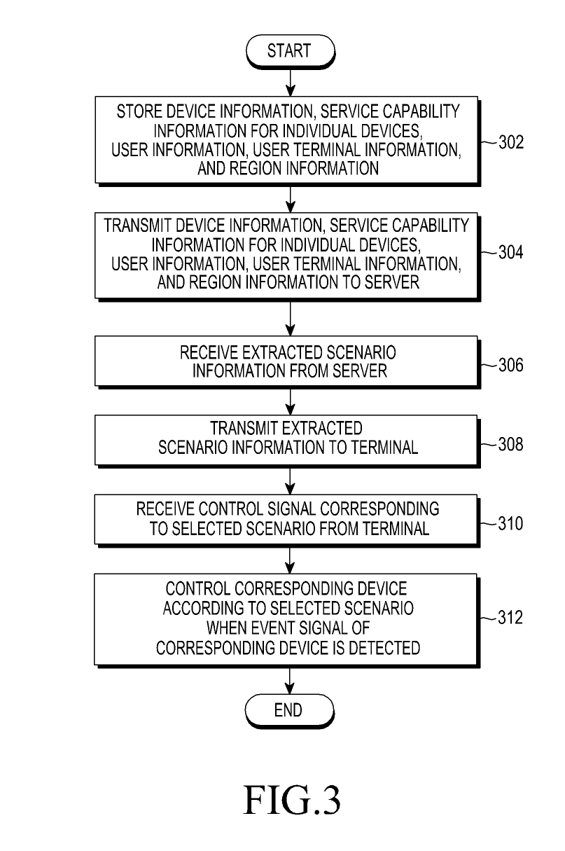

FIG. 3 is a flowchart of a method in which a home gateway operates in the second embodiment of the present disclosure.

Referring to FIG. 3, the home gateway may store at least one piece of information among device information including IDs respectively indicating home devices included in a home network system, that is, service capability information of the individual home devices installed in a home, user information, user terminal information, and region information, in operation 302. The home gateway may transmit the stored information to a server in operation 304, and receive extracted scenario information from the server in operation 306.

Then, the home gateway may transmit the extracted scenario information to a terminal in operation 308, and receive a control signal corresponding to a scenario selected by the terminal from the terminal in operation310. Then, if the home gateway detects an event signal of the corresponding device, the home gateway controls the device according to a process of the selected scenario in operation 312.

The extracted scenario information is information including scenarios configured with combinations of all services that can be provided to the user, and the extracted scenario information may be configured with services specialized for the corresponding user among all services that can be provided to the user, in consideration of at least one piece of information among the user information, the user terminal information, and information about a region in which the user lives. However, it is noted that the services and combinations of services provided to the user are not limited to the above and other types of services and combinations of services can be provided to the user. Further, also, the home gateway may transmit applications for executing the extracted scenarios, together with the extracted scenario information, according to whether the terminal stores the applications therein.

Thereafter, the home gateway can update device information if there is a change in devices installed in the home. For example, if a device has been newly installed in the home, the home gateway transmits a device ID and service capability information of the newly installed device to the server, and if a device installed in the home has been removed, the home gateway transmits information informing that the device has been removed, to the server, thereby updating device information.

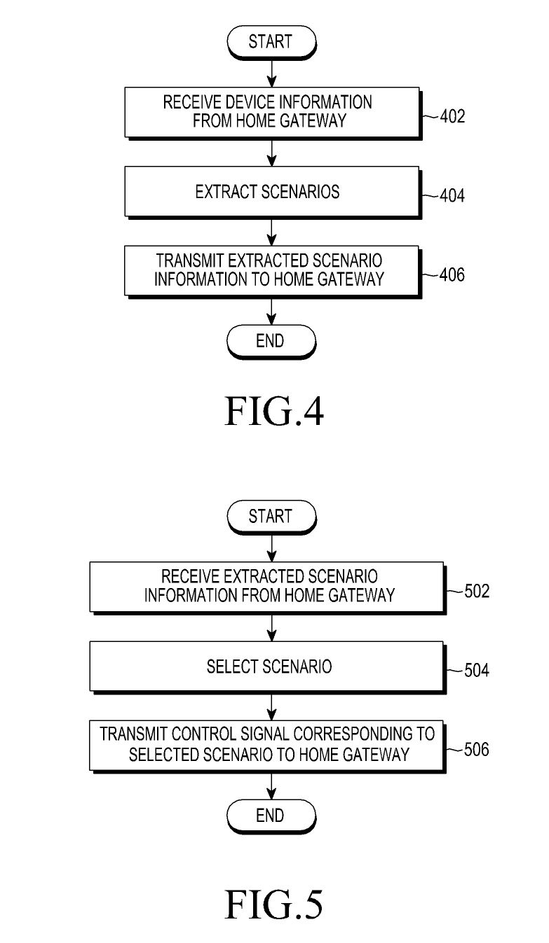

FIG. 4 is a flowchart of a method in which a server operates in the second embodiment of the present disclosure.

Referring to FIG. 4, the server may receive at least one piece of information among device information including an ID indicating a device, service capability information of the device, user information, user terminal information, and region information, from a home gateway, and store the received information, in operation 402.

Then, the server may extract scenarios configured with combinations of all services that can be provided to a user, based on the stored information, in operation 404. The server may transmit extracted scenario information including the extracted scenarios to the home gateway in operation 406. The extracted scenario information may be configured with services specialized for the corresponding user among all the services that can be provided to the user, in consideration of at least one piece of information among the device information, the user information, the user terminal information, and information about a region where the user lives. Also, the server may transmit applications for executing the extracted scenarios, together with the extracted scenario information, according to whether the terminal stores the applications therein. If there is a change in devices installed in the home, the server updates the device information that is considered in operation 404. For example, when a device has been newly installed in the home, the server receives a device ID and service capability information of the newly installed device, and when a device installed in the home has been removed, the server receives information informing that the device has been removed from the home gateway, thereby updating the device information.

FIG. 5 is a flowchart of a method in which a terminal operates in the second embodiment of the present disclosure.

Referring to FIG. 5, the terminal may receive extracted scenario information from a home gateway in operation 502. The extracted scenario information is information including scenarios configured with combinations of all services that can be provided to a user. Also, the terminal may receive applications for executing the extracted scenarios, together with the extracted scenario information, according to whether the terminal stores the applications therein.

Then, the terminal selects an optimal scenario from the extracted scenario information in operation 504, and transmits a control signal corresponding to the selected scenario to the home gateway in operation 506. The control signal includes a device ID included in the selected scenario, and information about a service that is provided by the corresponding device.

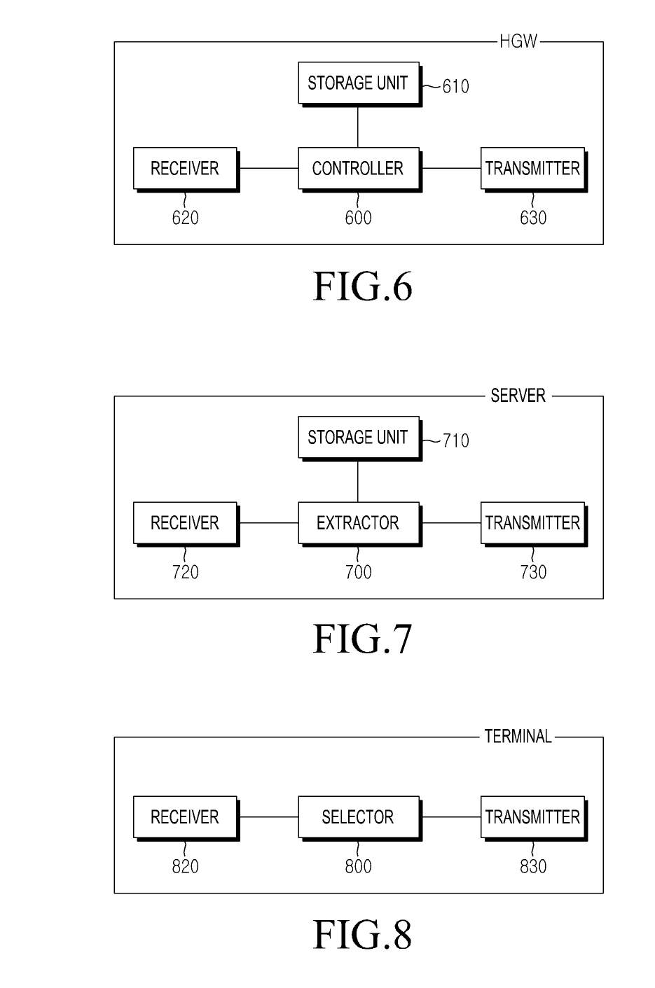

FIG. 6 is a block diagram illustrating a configuration of the home gateway in the second embodiment of the present disclosure.

Referring to FIG. 6, the home gateway includes a controller 600, a storage unit 610, a receiver 620, and a transmitter 630. When an event signal generated in a home network is detected, the controller 600 may control a device corresponding to the event signal according to a selected scenario, and transmit information informing that a device has been newly installed in the home network or that an installed device has been removed from the home network, to a server, to update device information. Also, the controller 600 may determine whether a terminal stores an application for executing the selected scenario therein, and if the terminal does not store the application for executing the scenario, the controller 600 may control the transmitter630 to transmit the application to the terminal. The storage unit 610 may store at least one piece of information among device information including IDs indicating devices, service capability information of the devices, user information, user terminal information, and information about a region where the user lives. The receiver 620 may receive at least one piece of information among information about home devices, service capability information of the individual home devices, user information, user terminal information, and region information, from the home devices. Also, the receiver 620 may receive extracted scenario information from the server, and receive a control signal corresponding to a scenario selected by the terminal from the terminal. The extracted scenario information may be configured with services specialized for the user among all services that can be provided to the user, according to at least one piece of information among the device information, the user information, the user terminal information, and the information about the region in which the user lives. The transmitter 630 may transmit at least one piece of information among the information about home devices, the user information, the user terminal information, and the information about the region in which the user lives. If a home device has been newly installed in the home, the transmitter 630 transmits information about the newly installed home device to the server, and if a specific home device among home devices installed in the home has been removed, the transmitter 630 transmits information informing that the specific home device has been removed, to the server. Also, the transmitter 630 may transmit the extracted scenario information to the terminal, and transmit an operation message to the corresponding device.

FIG. 7 is a block diagram illustrating a configuration of the server in the second embodiment of the present disclosure.

Referring to FIG. 7, the server includes an extractor 700, a storage unit 710, a receiver 720, and a transmitter 730. The extractor 700 may create extracted scenario information representing operation processes of scenarios, using at least one piece of information among device information including IDs indicating devices, service capability information of the devices, user information, user terminal information, and region information. The storage unit 710 may store applications for enabling a terminal to use the extracted scenario information, and store the extracted scenario information. The receiver 720 may receive information about home devices, service capability information of the individual home devices, user information, user terminal information, and region information from a home gateway. Also, if a home device has been newly installed in the home, the receiver 720 receives information about the newly installed home device from the home gateway, and if a specific home device among home devices installed in the home has been removed, the home gateway receives information informing that the specific home device has been removed, from the home gateway. The transmitter 730 may transmit the extracted scenario information and the applications to the home gateway. The extracted scenario information may be configured with services specialized for the corresponding user, among all services that can be provided to the user, in consideration of at least one piece of information among the user information, the user terminal information, and information about a region in which the user lives.

FIG. 8 is a block diagram illustrating a configuration of the terminal in the second embodiment of the present disclosure.

Referring to FIG. 8, the terminal includes a selector 800, a receiver 820, and a transmitter 830. The selector 800 may control the terminal's capability to execute an application, select one scenario among scenarios included in extracted scenario information, and generate a control signal corresponding to the selected scenario. The receiver 820 may receive the extracted scenario information from the home gateway. Also, the receiver 820 may receive an application for executing the scenario from the home gateway. The extracted scenario information may be configured with services specialized for the corresponding user, among all services that can be provided to the user, according to at least one piece of information among user information, user terminal information, and information about a region in which the user lives.

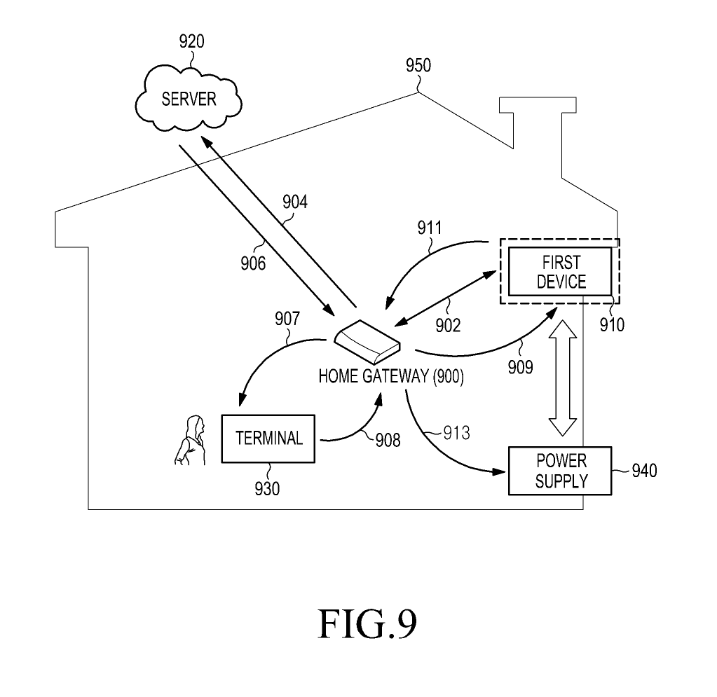

FIG. 9 illustrates a method of controlling a home device, according to a third embodiment of the present disclosure.

Referring to FIG. 9, a home network system 950 includes a terminal 930, a home gateway 900, a first device 910, a power supply 940, and a server 920. In the following description, it is assumed that the first device 910 is an oven installed in a home, and the power supply 940 is a device for supplying power to the oven. However, the first device 910 may be any other device installable in the home. Also, it is assumed that the terminal 930 is a smart phone, however, the terminal 930 may be any other device, such as a tablet PC and a notebook computer, which can communicate with the home gateway 900.

The home gateway 900 may register device information including IDs of all devices installed in the home, service capability information of the devices, information about a power supply for supplying power to the devices, user information, user terminal information, region information, etc., in operation 902. Then, the home gateway 900 may transmit the registered device information, user information, user terminal information, and region information to the server 920, in operation 904. For example, the device information may be device IDs, the user information may be family members' mobile phone numbers, gender, age, physical conditions, etc., the user terminal information may be information about applications stored in the corresponding terminal, and the region information may be a home address.

The service capability information of the devices is information about services that the devices can provide. The service capability information of the devices may be acquired through a service discovery procedure.

The server 920 may receive information about all devices installed in the home, user information, user terminal information, and region information, from the home gateway 900, stores the received information in a Data Base (DB) of the server 920, and extract scenarios configured with combinations of all services that can be provided to a user, based on the stored information.

The server 920 may transmit extracted scenario information for all services that can be provided to a user, to the home gateway, in operation 906. At this time, the server 920 may determine whether the terminal 930 stores applications for executing the corresponding scenarios based on the stored user terminal information, and if the terminal 930 does not store the applications, the server 920 may transmit the corresponding applications to the gateway 900 together with the extracted scenario information. The home gateway 900 may transmit the extracted scenario information and the applications be received from the server 920 to the terminal 930 in operation 907.

Also, when the server 920 transmits the extracted scenario information to the terminal 930 through the home gateway 900, the server 920 may transmit scenarios specialized for the corresponding user according to the stored user information and the region information.

The terminal 930 which has received the extracted scenario information provided from the server 920 through the home gateway 900 may select an optimal scenario, and transmit a control signal corresponding to the selected scenario to the home gateway 900, in operation 908. The control signal includes a device ID included in the selected scenario, and information about a service that is provided by the corresponding device. The home gateway 900 may detect a device to which the control signal is to be applied, according to the control signal and information about registered devices, and transmit the control signal to the detected device, in operation 909.

Thereafter, if the home gateway 900 detects an event signal of the detected device, the home gateway 900 controls the device according to a process of the selected scenario. However, if abnormal operation of the corresponding device, that is, the first device 910 is detected in operation 911, the home gateway 900 determines that the first device 910 has a problem, and controls the power supply 940 to stop supplying power to the first device 910 in operation 913. Herein, abnormal operation of the first device 910 for example home gateway 900 detect when signal transmission/reception to/from the first device 910 is unstable while the home gateway 900 controls the first device 910 according to the process of the selected scenario.

As described above, by proposing a method of providing a service to which a user's various requirements have been reflected using a server in a home network system, the user can receive an optimal service most suitable to himself/herself, resulting in performance improvement of the home network system.

The method and apparatus for controlling the home device, according to various embodiments of the present disclosure, may be implemented in the form of hardware, software, or a combination of hardware and software. The software may be stored in a volatile or non-volatile memory device such as, for example, a Read-Only Memory (ROM), regardless of whether it is erasable or re-writable, in a memory such as, for example, a Random Access Memory (RAM), a memory chip, and an Integrated Circuit (IC), or in an optically/magnetically recordable and machine-readable storage medium such as, for example, a Compact Disk (CD), a Digital Versatile Disk (DVD), a magnetic disk, and a magnetic tape. A graphic screen updating method can be implemented by a computer or a mobile terminal including a controller and a memory, and the memory is an example of a machine-readable storage medium suitable to store one or more programs, including instructions implementing various embodiments of the present disclosure.

Therefore, various embodiments of the present disclosure include programs including codes for implementing the devices and methods as set forth in the appended claims of the specification, and a machine-readable storage medium storing these programs. These programs may be electronically transferred through any media and equivalents thereof, such as communication signals, which are transferred through wired or wireless connections.

Also, the method and apparatus for controlling the home device, according to various embodiments of the present disclosure, can receive the program from a program providing apparatus connected in a wired/wireless fashion and store the program. The program providing apparatus may include a memory for storing programs including instructions instructing a graphic processing apparatus to perform a predetermined content protection method, information needed to perform the content protection method, etc.; a communication unit for performing wired/wireless communication with the graphic processing apparatus; and a controller for transmitting the corresponding program to a transmission and reception apparatus according to a request from the graphic processing apparatus or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling at least one home device in a home network system though a home gateway, the method comprising:
transmitting information about the at least one home device installed in a home, to a server;
receiving extracted scenario information configured with combinations of services that are provided through the at least one home device, from the server, and transmitting the extracted scenario information to a user terminal;
receiving a control signal corresponding to a selected scenario, from the user terminal; and
if an event signal is detected from the at least one home device corresponding to the selected scenario, controlling the at least one home device according to the selected scenario.

2. The method of claim 1, wherein the information about the at least one home device includes at least one of an identifier indicating the home device, and service capability information of the home device.

3. The method of claim 1, further comprising transmitting at least one piece of information among user information, user terminal information, and information about a region in which the user lives, to the server.

4. The method of claim 3, wherein the extracted scenario information is configured with services specialized for the user, among all services that are providable to the user, according to the at least one piece of information among the user information, the user terminal information, and the information about the region in which the user lives.

5. The method of claim 1, further comprising determining whether the user terminal stores an application for executing the selected scenario, and if the user terminal does not store the application, transmitting the application together with the extracted scenario information to the user terminal.

6. The method of claim 1, further comprising, if a home device has been newly installed in the home, transmitting information about the newly installed home device to the server.

7. The method of claim 1, further comprising, if a specific home device among the at least one home device installed in the home has been removed, transmitting information informing that the specific home device has been removed to the server.

8. The method of claim 1, further comprising:
receiving information about a power supply for supplying power to the home device; and
if abnormal operation of the home device is detected, controlling the power supply to stop supplying power to the home device.

9. A method for controlling at least one home device in a home network system through a server, the method comprising:
receiving information about the at least one home device installed in a home, from a home gateway;
extracting scenarios configured with combinations of services that are providable through the at least one home device; and
transmitting extracted scenario information including the extracted scenarios to the home gateway.

10. The method of claim 9, wherein the information about the at least one home device includes at least one of an identifier indicating the at least one home device, and service capability information of the at least one home device.

11. The method of claim 9, further comprising receiving at least one piece of information among user information, user terminal information, and information about a region in which the user lives, from the home gateway.

12. The method of claim 11, wherein the extracted scenario information is configured with services specialized for the user, among all services that are providable to the user, according to the at least one piece of information among the user information, the user terminal information, and the information about the region in which the user lives.

13. The method of claim 10, further comprising, if a home device has been newly installed in the home, receiving information about the newly installed home device from the home gateway.

14. The method of claim 10, further comprising, if a specific home device among the at least one home device installed in the home has been removed, receiving information informing that the specific home device has been removed, from the home gateway.

15. A method for controlling at least one home device in a home network system through a user terminal, the method comprising:
receiving extracted scenario information configured with combinations of services that are providable through the at least one home device installed in a home, from a home gateway;
selecting one scenario from among scenarios included in the extracted scenario information; and
transmitting a control signal corresponding to the selected scenario to the home gateway.

16. The method of claim 15, further comprising receiving an application for executing the selected scenario from the home gateway.

17. The method of claim 15, wherein the extracted scenario information is configured with services specialized for the user, among all the services that are providable to the user, according to the at least one piece of information among user information, user terminal information, and information about a region in which the user lives.

18. A home gateway configured to control at least one home device in a home network system, the home gateway comprising:
a receiver configured to receive information about the at least one home device installed in a home from the at least one home device, to receive extracted scenario information configured with combinations of services that are providable through the at least one home device, from a server, and to receive a control signal corresponding to a selected scenario from the user terminal;
a transmitter configured to transmit the information about the at least one home device to the server, and to transmit the extracted scenario information to the user terminal; and
a controller configured to control, if an event signal is detected from the at least one home device corresponding to the selected scenario, the at least one home device according to the selected scenario.

19. The home gateway of claim 18, wherein the information about the at least one home device includes at least one of an identifier indicating the at least one home device, and service capability information of the at least one home device.

20. The home gateway of claim 18, wherein the transmitter transmits at least one piece of information among user information, user terminal information, and information about a region in which the user lives, to the server.

21. The home gateway of claim 20, wherein the extracted scenario information is configured with services specialized for the user, among all services that are providable to the user, according to the at least one piece of information among the user information, the user terminal information, and the information about the region in which the user lives.

22. The home gateway of claim 18, wherein the controller determines whether the user terminal stores an application for executing the selected scenario, and if the user terminal does not store the application, the transmitter transmits the application together with the extracted scenario information.

23. The home gateway of claim 18, wherein if a home device has been newly installed in the home, the transmitter transmits information about the newly installed home device to the server.

24. The home gateway of claim 18, wherein if a specific home device among the at least one home device installed in the home has been removed, the transmitter transmits information informing that the specific home device has been removed to the server.

25. The home gateway of claim 18, wherein the receiver receives information about a power supply for supplying power to the at least one home device, and
if abnormal operation of the at least one home device is detected, the controller controls the power supply to stop supplying power to the at least one home device.

26. A server configured to control at least one home device in a home network system, the server comprising:
a receiver configured to receive information about the at least one home device installed in a home, from a home gateway;
an extractor configured to extract scenario information configured with combinations of services that are providable through the at least one home device; and
a transmitter configured to transmit the extracted scenario information to the home gateway.

27. The server of claim 26, wherein the information about the at least one home device includes at least one of an identifier indicating the at least one home device, and service capability information of the at least one home device.

28. The server of claim 26, wherein the receiver receives at least one piece of information among user information, user terminal information, and information about a region in which the user lives, from the home gateway.

29. The server of claim 28, wherein the extracted scenario information is configured with services specialized for the user, among services that are providable to the user, according to the at least one piece of information among the user information, the user terminal information, and the information about the region in which the user lives.

30. The server of claim 26, wherein if a home device has been newly installed in the home, the receiver receives the information about the newly installed home device from the home gateway.

31. The server of claim 26, wherein if a specific home device among the at least one home device installed in the home has been removed, the receiver receives information informing that the specific home device has been removed, from the home gateway.

32. A user terminal configured to control at least one home device in a home network system, the user terminal comprising:
a receiver configured to receive extracted scenario information configured with combinations of services that are providable through the at least one home device installed in a home, from a home gateway;
a selector configured to select one scenario among scenarios included in the extracted scenario information; and
a transmitter configured to transmit a control signal corresponding to the selected scenario to the home gateway.

33. The user terminal of claim 32, wherein the receiver receives an application for executing the selected scenario from the home gateway.

34. The user terminal of claim 32, wherein the extracted scenario information is configured with services specialized for the user, among all services that are providable to the user, according to the at least one piece of information among user information, user terminal information, and information about a region in which the user lives.
